(19) United States
(12) Patent Application Publication
(10) Pub. No.: US 2013/0318887 A1
(43) Pub. Date: Dec. 5, 2013

(54) Wall Capping Systems and Methods of Using Same

(71) Applicant: Thomas M. Murphy, Indian Wells, CA (US)

(72) Inventor: Thomas M. Murphy, Indian Wells, CA (US)

(21) Appl. No.: 13/945,813

(22) Filed: Jul. 18, 2013

Related U.S. Application Data
(63) Continuation-in-part of application No. 13/328,694, filed on Dec. 16, 2011.
(60) Provisional application No. 61/762,231, filed on Feb. 7, 2013.
(60) Provisional application No. 61/676,090, filed on Jul. 26, 2012.
(60) Provisional application No. 61/673,172, filed on Jul. 18, 2012.
(60) Provisional application No. 61/424,498, filed on Dec. 17, 2010.
(60) Provisional application No. 61/444,080, filed on Feb. 17, 2011.

(51) Int. Cl. G08B 13/22; E04F 19/00

(52) U.S. Cl. CPC G08B 13/22; E04F 19/00
USPC 52/27

(57) ABSTRACT

Described herein are systems for both preventing intrusion by an unwanted party and/or detection of a local event.

### CROSS REFERENCE TO RELATED APPLICATIONS

This application claims the benefit of U.S. provisional patent applications No. 61/762,231, filed Feb. 7, 2013, No. 61/676,090, filed Jul. 26, 2012, and No. 61/673,172, filed Jul. 18, 2012, the entire disclosures of each of which is incorporated herein by reference

This application is a continuation-in-part of U.S. patent application Ser. No. 13/328,694, filed Dec. 26, 2011, which claims the benefit of U.S. provisional patent applications No. 61/424,498, filed Dec. 17, 2010 and No. 61/444,080, filed Feb. 17, 2011, the entire disclosures of each of which is incorporated herein by reference.

### FIELD

The present disclosure relates to wall capping systems with intrusion prevention and/or detection systems.

### BACKGROUND

The possession of valuable goods and the desire to keep loved ones safe generally requires systems and methods for protection and/or detection at the property perimeter or on a wall or fence surrounding the property. Whether valuable goods are small items like pieces of jewelry, important documents or the like, or large items like automobiles, televisions, artwork, or even a human being, a system and methods for protecting these items against theft or vandalism or preventing bodily harm is essential.

However, such methods merely slow down a burglar. As technology evolves, so must the protection methods of possessions and loved ones. People commonly lock away valuables within their home and park their expensive cars within a locked garage. At this point, preventing burglars from even getting to the home or at least notification that an intruder is attempting to enter the property, such as over a wall, would be ideal.

Various types of security are commonly implemented on perimeters of both personal property (e.g., residential), perimeters of associations or communities or industrial or commercial areas. These include roaming patrol, video surveillance, numerous types of motion detection, and various types of walls with prevention measures at the tops such as razor wire or even in primitive situations, broken glass bottles. Despite these measures, once a burglar has surpassed one or more of these measures, it becomes a burden to track the burglar down and depending on the size of the protected area, it may become an elaborate and time consuming process.

Systems for merely detection and reporting and not alarming are commonly implemented when safety is an issue or a need to capture a criminal in the act is desired. Silent alarms generally detect an intrusion and report it to local authorities without the need to alter the local situation to enhance local safety. Detection systems are also needed in many situations than just security systems.

Accordingly, a need exists for the further development of perimeter security systems and/or detection and reporting systems.

### SUMMARY

Generally described herein are systems that can be installed on or around a wall, barrier, or other structure and carry high and/or low voltage power, various forms of data, communication lines, proximity sensors or sensor systems, and the like. The systems described can be used as security systems for both preventing intrusion by an unwanted party and locating where the attempted intrusion occurred. The systems described herein can also be used to sense an event and optionally report it to a remote system.

Described herein in one embodiment are security systems comprising: a structure topped with one or more layers of a binding agent, and at least one proximity sensor encased within the structure having at least two layers of the binding agent. In one embodiment, two or more layer of binding agent can be used. The systems can further include at least one elongated coupling member, such as a length of foam fitted for a particular application, between the structure and the at least two layers of the binding agent.

Methods of securing an area of land are also described comprising: arming a security system on an existing structure, wherein the security system includes a foundation material, a first encasing layer, a proximity sensor, a second encasing layer, and a top material; and securing the area of land.

In some embodiments, the elongated coupling members can be formed of foam, the foundation material and the top material are formed of rubber, and/or the first encasing layer and the second encasing layer are formed of fabric or textile. The systems can further include a first encapsulating layer and a second encapsulating layer surrounding the at least one proximity sensor. In other words, the proximity sensor can be encased in the first encasing layer and the second encasing layer, and the first encasing layer and the second encasing layer are encased in the foundation material and top material. The at least one elongated coupling member can be attached to the structure using an adhesive or can be bolted or screwed to the structure.

The at least one proximity sensor system can include at least one of a motion detection system, a pressure detection system, a shock detection system, an impact detection system, an infrared detection system, or the like, or a combination thereof. The at least one proximity sensor system may be housed within the at least one conduit channel. In other embodiments, the proximity sensor system can be a sensor tape system, a tape switch system, a nano-power tilt and vibration sensor system, or another electronic device that senses vibration or changes or variations in weight. With a tape system, the presently described systems can measure the distance on the tape that an event has occurred to aid in pinpointing the location of the event. Overall, the security systems generally can add less than about 4 inches of height to the structure. In some embodiments, the security systems can add less than about 1 inch to the structure.

Security systems are also described comprising: a proximity sensor encased in a fabric layer, wherein the fabric layer encased within a vulcanized rubber material, and wherein the vulcanized rubber material applied to the top of a structure. In some embodiments, the structure is a perimeter structure. In some embodiments, the structure can include walkways, walls, fences, roof lines, parapets, windows, platforms, platform edges, door thresholds, barriers, combinations thereof, or the like.

Monitoring systems are also described that can report an event to a remote system. Such a monitoring system can comprise: at least one elongated coupling member including at least one internal conduit coupled to a wall; and at least one proximity sensor running through the at least one conduit. In one embodiment, the wall is a jersey barrier. Such a system can be used to detect an automobile accident and optionally report it to a remote system. The remote system can include a server, personal computer, fax machine, home automation system, tablet, smart phone, cell phone, land line phone, law enforcement dispatch, emergency dispatch, and the like.

Methods of detecting a traffic collision are described comprising: detecting an impact with a barrier including a system comprising at least one elongated coupling member coupled to a structure including at least one conduit; and at least one line proximity sensor running through the at least one conduit. The method can further comprise the step of reporting the impact to a remote computing system. The remote computing system can include any device including a microprocessor and/or possessing an internet protocol (IP) address. The remote computing system can include a server, personal computer, fax machine, home automation system, tablet, smart phone, cell phone, and the like.

In some embodiments, the systems further comprise a protective cap over the elongated coupling member.

Also described are wall caps including at least one elongated coupling member comprising at least one conduit; and at least one line proximity sensor running through the at least one conduit. The elongated coupling members can include at least two conduits and stand about 2 inches to about 8 inches tall. In one embodiment, six conduits are included. The conduits can be internal conduits, adjacent conduits, or both. The conduits can further include data lines, communication lines, power lines, fiber optic lines, structural bracing lines, or a combination thereof.

In one embodiment, the system is configured to detect an impact and log that impact on a remote computer. The remote computer can include any device including a microprocessor and/or possessing a internet protocol (IP) address.

Additional features and advantages are described herein, and will be apparent from the following Detailed Description and figures.

### BRIEF DESCRIPTION OF THE DRAWINGS

FIG. 1 illustrates an interior view (from secured area) of an exemplary security system according to the present disclosure.

FIG. 2 is a cross-sectional view of FIG. 1.

FIG. 3 is an aerial view of a security system according to the present disclosure.

FIG. 4 illustrates a perspective view of an alternate security system according to the present disclosure.

FIG. 5 is a cross-sectional view of FIG. 4.

FIG. 6 illustrates a perspective view of an alternate security system according to the present disclosure.

FIG. 7 is a cross-sectional view of FIG. 6.

FIG. 8 illustrates a monitoring system coupled to the top of a jersey barrier commonly used on highways.

FIG. 9 is a cross-sectional view of FIG. 8.

FIG. 10 illustrates another monitoring system coupled to the top of a jersey barrier commonly used on highways.

FIG. 11 is a cross-sectional view of FIG. 10.

FIG. 12 illustrates another monitoring system coupled to the top of a jersey barrier and including an armored cap.

FIG. 13 is a cross-sectional view of FIG. 12.

FIG. 14 illustrates an example schematic of a control module.

### DETAILED DESCRIPTION

Generally described herein are wall capping systems that can carry power, data, proximity sensor systems and the like, and can be added to an existing structure. A structure can include, but is not limited to walkways, walls, fences, roof lines, parapets, windows, platforms, platform edges, door thresholds, barriers, or the like. Such systems can also be added or integrated into newly formed structures, walls and/or barriers. The systems described can also be used as security systems for preventing intrusion by an unwanted party, person, large animal and egress from within the protected area. The systems described can also be used to locate where the attempted intrusion and/or egress occurred. The security systems, in a broad aspect, comprise a physical structure including for example, a wall, a binding agent, and at least one proximity sensor system associated with the binding agent. Optionally, the proximity sensor can be associated with an elongated coupling member. Further, one or more partitioning members can be associated with the systems.

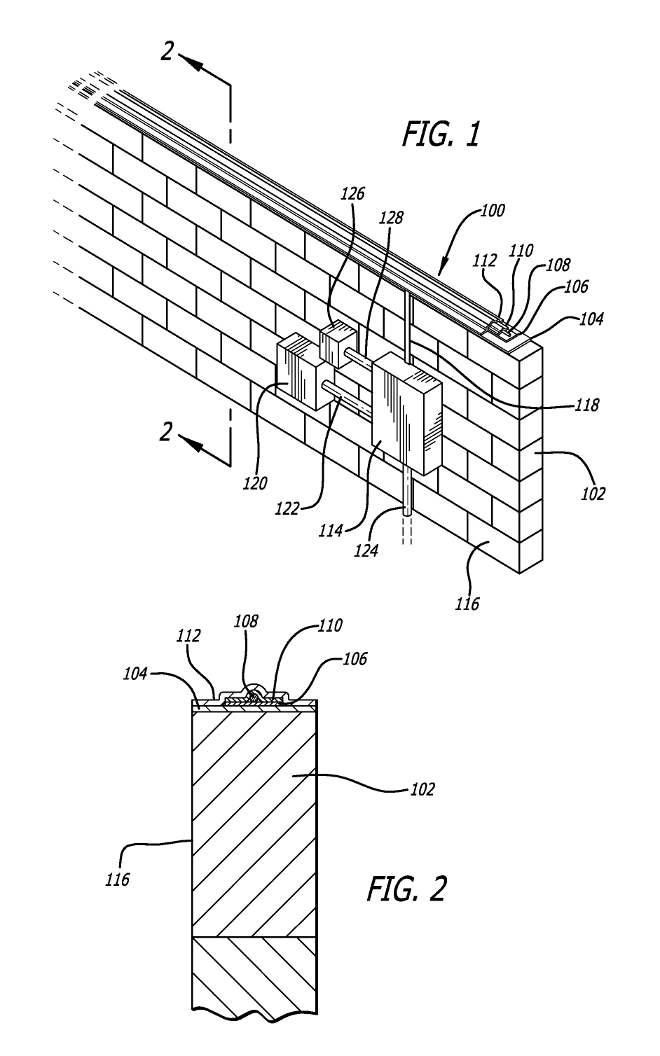

System 100 described herein can generally include, as illustrated in FIGS. 1 and 2, wall 102, a first binding agent such as foundation material 104, optional first encasing layer 106, proximity sensor 108, optional second encasing layer 110, and a second binding agent such as top material 112. In some embodiments, one or both of the encasing layers need not be used. In other embodiments, a single encasing layer is folded over a sensor or proximity wire.

Wall 102 or any wall, barrier, structure described can be formed of any suitable material known in the art. Materials may include cinder block, slump stone, cement, marble, stone, rock, wood, brick, chain link, glass, and the like.

A wall can further be formed of foam blocks cut into brick or stone dimensions and installed similar to a brick or stone wall. Foam blocks can be held together using any adhesive described herein or mortar. Once the wall is built, it can be sprayed and sealed using a polymeric coating material described herein.

A wall, barrier, structure can also be a barrier not to prevent intrusion, but to preventingress or egress. Barriers can be in the form of jersey walls or jersey barriers, water barriers, dams and the like. Barriers can be formed of materials such as, but not limited to concrete, high density polymer, polymer tanks filled with sand, water or other material, metal, rock, or the like.

In some example embodiments, the systems may be added to an existing wall. Such systems can be advantageous when local, state or federal ordinances restrict one's ability to add height to an existing wall. For example, in California where earthquake codes restrict block walls from being erected beyond six feet in height without cost prohibitive footings, the security systems described herein can be ideal.

In other situations, a system may be advantageous over adding additional height to an existing wall that would not match the already existing aged walls. In other embodiments, simplicity of the systems described herein may be desirable.

Even further still, the systems described herein can be virtually invisible to the naked eye. In cases of security systems as described herein, they can be visually appealing. In any case, the systems described herein can be more effective when compared to common wall top security systems such as razor wire, spikes, or even glued down broken glass bottles.

Although described on top of a wall, the present systems when used for security and/or detection virtually anywhere it is required. Systems can be installed on structures such as along the edges of a roof line, around a window, along the side of a wall, along the ground, around the perimeter of a boat/ship, along the base of a garage door, or the like. Any location where foundation material, top material, and/or elongated coupling members can be applied, the present systems can be installed.

Proximity sensors can include any fence or wall intrusion detection or proximity sensor system. For example, proximity sensors such as microwave cable systems, microphonic cable systems, and fiber optic cable systems can be adapted to the present systems. Further, motion detection systems can be incorporated. Cable systems described can be reinforced with polymers, tapes, and/or fabric encasings. In one embodiment, cables can be reinforced with Kevlar. In other embodiments, the cables can be encased in a polymer and adhesive applied to a portion thereof.

A proximity sensor can be placed inside a conduit that is installed where the proximity sensor would be installed, and then a sensor wire or loop is fed through the conduit. Any location herein where a wire or loop is associated with the systems can be installed inside a conduit. In fact, if conduits are used, they can house additional electronics or can allow removal an installation of newer, and/or updated wire systems as technology changes. A conduit can have a diameter of about ¼ inch, about ½ inch, about ¾ inch, about 1 inch, about 1.5 inches, about 2 inches or any suitable diameter. In some embodiments, multiple conduits can be used.

A proximity sensor can be provided as a system including a fiber optic line. In such a configuration, only a single strand of wire may be needed as opposed to a fiber optic loop. The proximity sensor can be controlled by controller module 114. Such systems can detect intrusion within about 1 ft, about 5 ft, about 10 ft, about 20 ft, or about 50 ft. In some embodiments, intrusion detection can be within about 10 ft or within about 5 ft. In another embodiment a fiber optic loop having an outbound wire and an inbound wire can be used. Both outbound wire and inbound wire are terminated and ultimately controlled by controller module 114. Depending on the proximity sensor system utilized, multiple sensors can be located along fiber optic line and trigger a sensor.

A microwave proximity sensor system can also be used in place of or in addition to a fiber optic wire or loop. This proximity sensor system can include, in this particular example, an analogue cable terminated and ultimately controlled by controller module 114. Depending on the proximity sensor system utilized, multiple sensors can be located along the analogue cable and can trigger a sensor.

A motion detection system can also boarder or sourround the outside of a security system. Laser systems that surround can be advantageous. Different lengths of laser motion detection systems can be used. For example, 500 foot spans can be used, or 1,000 foot spans, or 2,500 feet or more can be used. A break in the laser system can trigger an alarm or a particular light configuration as described herein.

Any laser beam system known in the art can be used with the present security systems. In an example embodiment, the laser light beam is a red visible laser light. In other embodiments, the laser light beam is a green visible laser light. In other embodiments, beams such as infrared beams that are not detectable to the human eye are desirable.

Binding agents such as foundation material 104 and top material 112 can be the same or different. Binding agents can include a material selected from thermosets, thermoplastics, solidified gels, tar, stucco, resin, rubber, vulcanized rubber, synthetic rubber, cement, silicone polymers, polyolefins, polyisobutylene, acrylic polymers, ethylene-co-vinylacetate, polybutylmethacrylate, vinyl halide polymers (for example, polyvinyl chloride), polyvinyl ethers (for example, polyvinyl methyl ether), polyvinylidene halides, polyacrylonitrile, polyvinyl ketones, polyvinyl aromatics, polyvinyl esters, acrylonitrile-styrene copolymers, ABS resins, ethylene-vinyl acetate copolymers, polyamides (for example, Nylon 66 and polycaprolactam), alkyd resins, polycarbonates, polyoxymethylenes, polyimides, polyethers, epoxy resins, polyurethanes, rayon, cellulose, cellulose acetate, cellulose butyrate, cellulose acetate butyrate, cellophane, cellulose nitrate, cellulose propionate, cellulose ethers, carboxymethyl cellulose, polytetrafluororethylene (for example, Teflon), combinations thereof, and the like. In one embodiment, the coating can be for example a vulcanized rubber. Further, the material can have a UV resistant component to prevent excessive wear from sunlight. Once applied, the material can withstand puncture, scratching, or water ingress. In one embodiment, the materials are a rubber such as RUBERIZE IT®.

The thickness of a material layer or layers can depend on the particular application. Thickness can be from about 0.25 mil to about 50 mil, from about 0.25 to about 100 mil, from about 0.25 to about 500 mil, or from about 0.25 mil to about 1,000 mil, at least about 0.25 mil, at least about 10 mil, at least about 25 mil, or at least about 50 mil. In one embodiment, the thickness is about 10 mil or about 20 mil. In other embodiments, the thickness can be larger. In other embodiments, the entire material thickness can be about 0.5 mm, about 1 mm, about 1.5 mm, about 2 mm, about 2.5 mm, about 3 mm, about 3.5 mm, about 4 mm, about 4.5 mm, about 5 mm, about 6 mm, about 7 mm, about 8 mm, about 9 mm, about 10 mm, about 15 mm, about 20 mm, about 25 mm, about 30 mm, about 40 mm, or about 50 mm, at least abut 0.5 mm, at least about 1 mm, at least about 10 mm, or greater.

The width of a material layer can be about 1 inch, about 2 inches, about 3 inches, about 4 inches, about 5 inches, about 6 inches, about 7 inches, about 8 inches, about 9 inches, about 10 inches, at least about 1 inch, at least about 2 inches, at least about 5 inches, or greater. In one embodiment, the width can be about 3 inches.

First encasing layer 106 and second encasing layer 110 can be optional. If used, first encasing layer 106 and second encasing layer 110 can be two different material layers or can be a single layer folded upon itself. First encasing layer 106 and second encasing layer 110 can be textile or fabric based and can be formed of polyester, cotton, rayon, wool, silk, vinyl, or a combination thereof. In one embodiment, first encasing layer 106 and second encasing layer 110 are a wall fabric material.

The width of either first encasing layer 106 and second encasing layer 110 can be about 1 inch, about 1.5 inches, about 2 inches, about 3 inches, about 4 inches, about 5 inches, about 6 inches, about 7 inches, or about 8 inches. In one embodiment, the width can be about 1.5 inches. The widths of both first encasing layer 106 and second encasing layer 110 are shorter than the width of foundation material 104 and top material 112. If first encasing layer 106 and second encasing layer 110 are formed by folding a fabric or textile material, it is preferred that the material be folded in half. If first encasing layer 106 and second encasing layer 110 are separate, in some embodiments, they can have the same width.

As illustrated in FIG. 1, when used as a security system, controller module 114 can be, for example, mounted on inner face 116 of wall 102. In this example, controller module 114 mounts on inner face 116 so that potential burglars do not have the ability to easily access it. Controller module 114 can be connected to and control the at least one proximity sensor system via cable 118. Controller module 114 can further include at least one battery (not illustrated) that can be charged by an external source 120 via charging cable 122. External source 120 can be, for example, a solar panel, wind turbine or the like. Controller module 114 can further be powered by an external power grid through main conduit 124. In one embodiment, a controller module is located in a lockable environment. For example, a controller module can be mounted in a lockable controller box, lockable control room, server closet, or the like.

In one embodiment, controller module 114 can include at least one processor, such as a microprocessor, a microcontroller-based platform, a suitable integrated circuit or one or more application-specific integrated circuits (ASIC's). The processor is in communication with or operable to access or to exchange signals with at least one data storage or memory device. In one embodiment, the processor and the memory device reside together. The memory device can store program code and instructions, executable by the processor, to control the security system, proximity sensor, or any other part of a security system. The memory device also stores other data such as image data, event data, input data, random or pseudo-random number generators, table data or information, and applicable rules that relate to the security system. In one embodiment, the memory device includes random access memory (RAM), which can include non-volatile RAM (NVRAM), magnetic RAM (MRAM), ferroelectric RAM (FeRAM), and other forms as commonly understood in the gaming industry. In one embodiment, the memory device includes read only memory (ROM). In one embodiment, the memory device includes flash memory and/or EEPROM (electrically erasable programmable read only memory). Any other suitable magnetic, optical, and/or semiconductor memory may operate in conjunction with the gaming device disclosed herein.

Controller module 114 can further include connection points from external sensors used, contacts and relays, time delayed contacts, time delayed relays, proximity sensors, internal battery unit, battery charger (e.g., external), indicator lights (e.g., to show function, mode or condition of the system), Ethernet, wireless communication device, and/or cellular modem device. In one embodiment, connection points for eight or more contacts and relays are included. In some embodiments, the battery can sustain the system for at least about 1 hour, at least about 2 hours, at least about 3 hours, at least about 4 hours, at least about 6 hours, between about 2 hours and about 6 hours, between about 2 hours and about 24 hours, or the like.

The one or more processors are electrically coupled by an address/data bus to one or more memory devices, other computer circuitry, and one or more interface circuits. The processor may be any suitable processor, such as a microprocessor from the INTEL®, NVIDIA®, or AMD® family of microprocessors. The memory preferably includes volatile memory and non-volatile memory. Preferably, the memory stores software programs that can interact with the other devices in the system or external devices such as tablets or smart phones. Programs may be executed by the processor in any suitable manner. In an example embodiment, memory may be part of a “cloud” such that cloud computing may be utilized by the security systems.

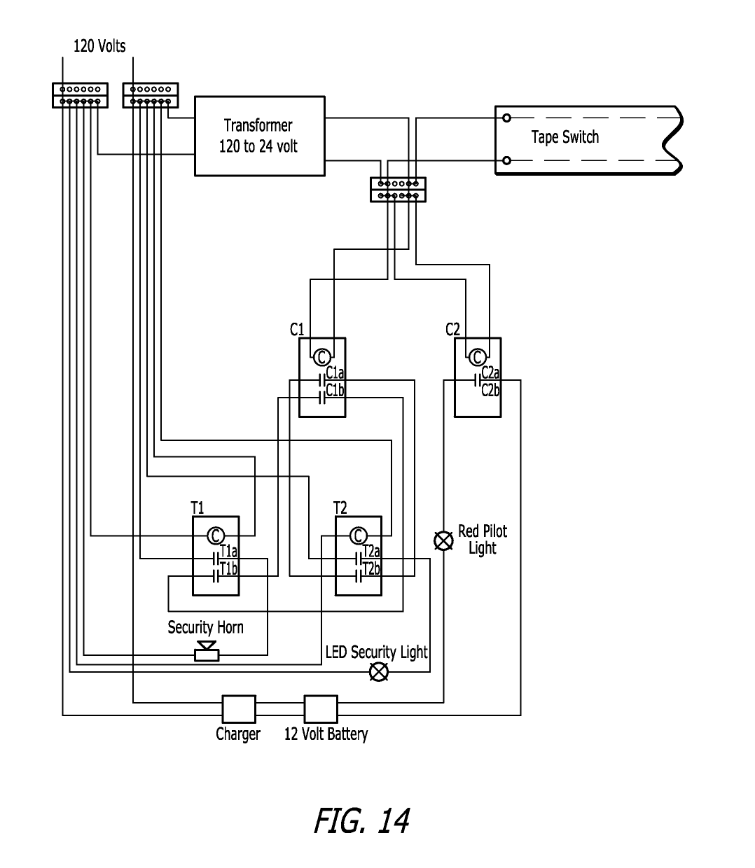

An example controller module is illustrated in the schematic in FIG. 14. Individual components can be removed and replaced as necessary depending on a particular need or configuration.

Controller module 114 can further communicate, in some embodiments, with a main controller system, for example, in a security headquarters which may be located on the protected property. Controller module 114 can connect via a communication line within main conduit 124 to a mainframe or server computer system. In other embodiments, communication with the main controller system is via a wireless signal from antenna 126 through signal cable 128. Any wireless protocol known in the art can be used, but preferably, the wireless signal can be encrypted above 64 bit, 128 bit, 256 bit, 512 bit, or 1024 bit.

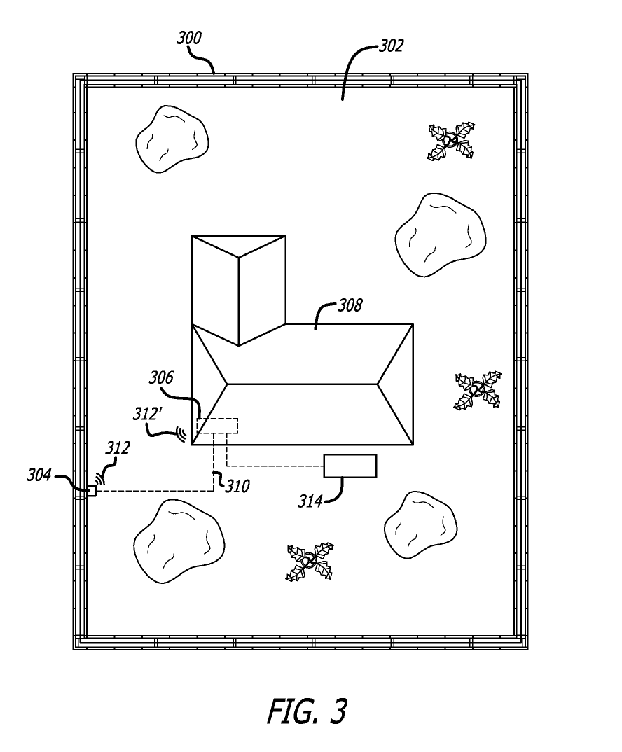

As an example, FIG. 3 illustrates how a security system as described can communicate and be controlled. Secured wall 300 including a security system as described herein surrounds the entirety of property 302. Control module 304 is located somewhere within secured wall 300. Control module 304 can communicate with main computer 306 within house 308 via communication line 310. Control module 304 can also communicate with main computer 306 via wireless signal 312, 312′. Further still, controller module 304 can communicate with an offsite computer via telephone or fiber optic lines (not illustrated) or via a long range wireless signal such as a cellular network or satellite communication.

Main computer 306 can control each electronic function of the security systems described herein. For example, computer 306 can arm or disarm the entire system or any portion thereof. It can, for example, relay warning signals, dispatch onsite security, or contact law enforcement automatically. It can collect data about the system including attempted intrusions, power usage and savings, malfunctions and light burnouts (to be discussed later), and the like.

The entire system can further comprise a redundant power system 314. One or more onsite power supplies are on standby in case external power is disrupted. These power supplies can be, for example, generators or batteries charged by solar panels. In some embodiments, the entire system is self contained in that all power is generated on site.

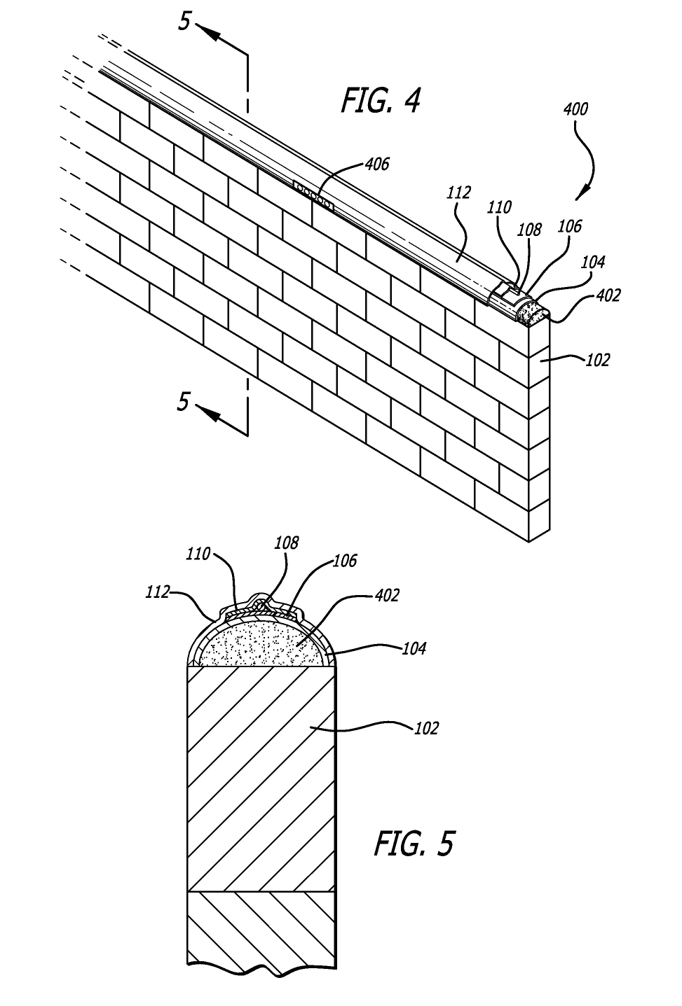

FIG. 4 illustrates another embodiment of a system as described herein. Security system 400 includes wall 102, elongated coupling member 402, foundation material 104, optional first encasing layer 106, proximity sensor 108, optional second encasing layer 110, and top material 112. Elongated coupling member can be added in order to enhance visual appeal, create a uniform top to wall 102, to add additional flexibility to the top of wall 102, or a combination thereof.

Elongated coupling members as described herein can be formed from any appropriate material. Such materials include, but are not limited to, thermosets, thermoplastics, foams, coated foams, gels, and the like. The material may need to be rigid enough to hold an appropriate weight on top of the wall yet flexible enough to move when touched. The outside of the material may have physical properties allowing it to hold up to heat, cold, ultraviolet light, rain, and the like over time.

In one example embodiment, elongated coupling members are formed of foam, for example compressed polystyrene. Compression ratios for the foams can be about 0.50, 0.60, 0.70, 0.75, 0.80, 0.90, or 1.0. The compression ratio can vary depending on, for example, the weight bearing load needed. In one embodiment, the foam is about 0.5 lb, 1.0 lb, 1.5 lb 2.0 lb or 2.5 lb foam.

The foam can be coated prior to application with a foundation material or even prior to being placed on a wall, barrier, or structure with a material selected from thermosets, thermoplastics, solidified gels, tar, stucco, resin, rubber, cement and the like. The coating can be, for example, a thermoplastic polyurethane and/or polyurea. The coating can further armor the foam and as a result the elongated coupling members can resist torture such as puncturing. Once coated with such a coating material, the foam is able to withstand puncture, scratching, or water ingress. A substance similar to resin sprayed in truck beds can be used to armor the foam.

In some embodiments, elongated coupling members can be custom crafted using hot-wire sculpting to fit any type of décor or landscape theme. The coating can be of varying thickness depending on the particular application. Thickness can range from about 0.25 mil to about 50 mil. In one embodiment, the thickness is about 10 mil or about 20 mil. In other embodiments, the entire coating can have a thickness of about 0.5 mm, about 1 mm, about 1.5 mm, about 2 mm, about 2.5 mm, about 3 mm, about 3.5 mm, about 4 mm, about 4.5 mm, about 5 mm, about 6 mm, about 7 mm, about 8 mm, about 9 mm, about 10 mm, about 15 mm, about 20 mm, about 25 mm, about 30 mm, about 40 mm, or about 50 mm.

Elongated coupling members can be tailored to fit the top of any existing wall, barrier, or structure. For example, elongated coupling members can fit on a wall with a square top. Or, the elongated coupling members can fit on a wall with a rounded top. Elongated coupling members can attach to non-uniform wall tops. A rigid non-uniform wall top can be leveled with an appropriate concrete or mortar before installing elongated coupling members.

Further, elongated coupling members can be fabricated to include indentations for partitioning members added on top, so that the partitioning members can sit snuggly on top of the elongated coupling members. Holes for installing mounting hardware (discussed below) can also be included. Partitioning members are described in U.S. patent application Ser. No. 13/328,694 which is incorporated herein in its entirety.

In some example embodiments, elongated coupling members have at least one channel to run at least one proximity sensor system down the length thereof. In other embodiments, the elongated coupling members have two, three, four five, six, seven or more channels running through them. This channel can be deep enough to fully conceal the proximity sensor wire within the channel. In one example embodiment, elongated coupling members have two channels to house a loop of proximity sensor wiring. In one channel the outbound wiring is housed and the inbound wiring is housed in a second channel. In another embodiment, elongated coupling members have one channel to house a proximity sensor wire. Once wires are embedded within the channels, they can be caulked in place to protect the wires from elements such as, but not limited to, weather.

Channels can be bored into elongated coupling member in virtually any configuration. For example, two holes can be bored in each outer edge on the elongated coupling member to hold a proximity sensor wire and a direct current power line. Further, a channel can be bored, for example, under the partitioning member for wires such as, for example, LED lighting strips or individual LED lights.

Further, elongated coupling members can be cut at desired angles for assembling the security system. For example, 90° cuts and end caps where a wall ends, are useful. Further, miter cuts of the elongated coupling members are useful for turns in the wall, for example, a set of 45° miter cuts gives a 90° turn in the wall. Beveled cuts are also useful for elevation changes in a wall. Again, a set of 45° bevel cuts gives a 90° elevation change in the wall. Combinations of miter and bevel cuts can be made on the elongated coupling members to account for virtually any turn or elevation change in the wall.

Cuttablility of elongated coupling members can aid in repair of a security system over time. Damage to a security system section may require that an assembled section be cut out and removed without substantially damaging a wall, barrier, or structure. The materials used to form the elongated coupling members are cuttable under such circumstances.

In other embodiments, elongated coupling members can be formulated as preconfigured units including built in wiring, proximity sensor(s), lights and the like as desired for a particular installation. Upon installation, each preconfigured unit can have plugs at each end that connect together with adjacent preconfigured units for easy installation.

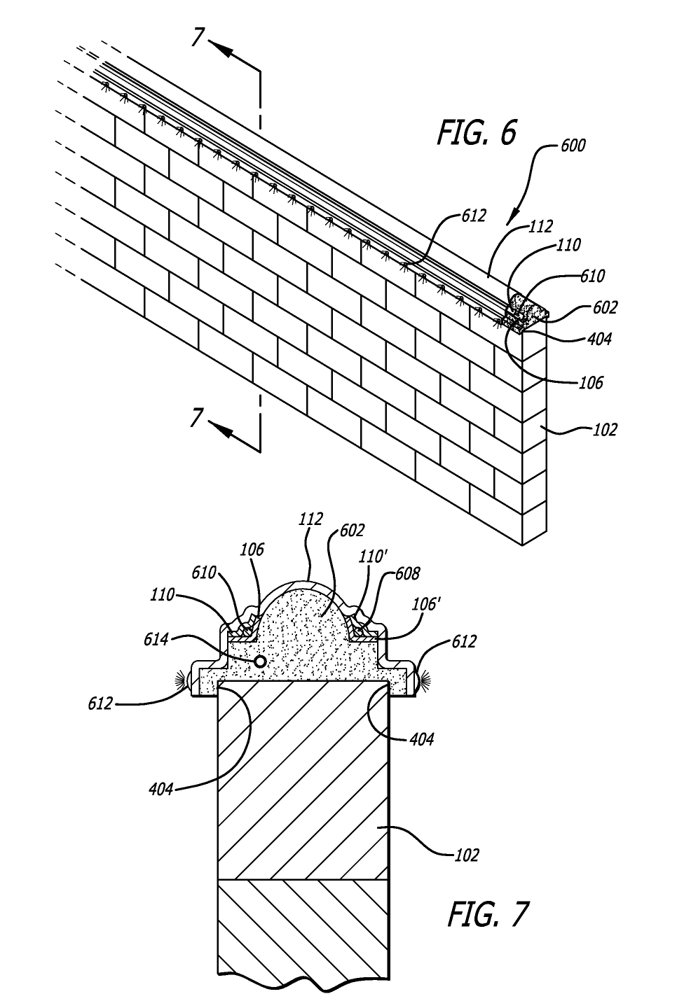

The size of wall 102 dictates the physical dimensions of elongated coupling members 402. For example, if wall 102 is formed of a standard 6 inch deep cinder block, then elongated coupling members 402 have a matching channel 404 on the bottom as illustrated in FIGS. 6 and 7. In the case of a 6 inch cinder block, matching channel 404 might be 6 inches wide or even 6.25 inches wide to account for variations in block depth.

The height of the elongated coupling members are generally on the order of about 2 inches to about 10 feet or more. In other embodiments, the elongated coupling members are about 3 inches to about 3 feet tall. In yet other embodiments, the elongated coupling members are about 6 inches to about 2 feet tall.

Lengths of elongated coupling members are dependent on the scope of security system being installed. In most cases, to save on cost, 2 ft, 4 ft, 6 ft, 8 ft or even 12 ft lengths might be ideal wherein appropriate lengths are cut at the installation site. However, short lengths such as 1 ft or less can be produced.

Elongated coupling members are generally coupled to a wall, barrier, or structure using an adhesive such as acrylic latex, polystyrenes, polyurethanes, and combinations thereof. Any common type of construction adhesive such as caulks, cements, mortars, polymeric adhesives and the like can be used. In addition to or as an alternative to adhesive, elongated coupling members can be anchored to a wall, barrier, or structure. Bolts and masonry anchors with washers can hold elongated coupling members in place. In one example embodiment, elongated coupling members are both glued and anchored to a wall, barrier, or structure.

In another embodiment, elongated coupling members can be coupled to a wall, barrier, or structure using a strap or tie. Straps and ties can be made of any suitable material. Suitable materials can include rope, metal, fabric, and the like. In one embodiment, a metal strap is used and clamped to prevent removal. In another embodiment, a fabric tie down system is used similar to systems used to hold cargo in a vehicle. The strap or tie can be secured through a hole in an elongated coupling member, such as a hole cut through an elongated coupling member and reinforced with a device such as a piece of PVC pipe or metal pipe. Also the tie or strap can be secured through a complimentary hole in the wall, barrier, or structure optionally reinforce as described above. In other embodiments, features can be added to the elongated coupling members and/or wall, barrier, or structure that allow straps or ties to be secured. Such features, can be snaps, bolds, hooks and the like.

Elongated coupling members can also be attached to a wall, barrier, or structure using friction. Channel 404 can be cut to such a dimension that it can hold itself onto a wall, barrier, or structure using friction alone. As such, in some embodiments, no adhesive and no anchors need to be used to secure elongated coupling members 402 to a wall, barrier, or structure.

Further still, elongated coupling members 402 can be configured with a protruding channel along the bottom such that a groove is cut into the top of an existing wall and the elongated coupling members' protruding channel is placed into the newly cut groove. Again, the elongated coupling members can be glued or physically bolted down once placed within the groove atop the existing wall.

Another embodiment is illustrated in FIGS. 6 and 7. Security system 600 includes wall 102, elongated coupling member 602, optional first encasing layer 106, 106′, first proximity sensor 608, second proximity sensor 610, optional second encasing layer 110, 110′, and top material 112. Elongated coupling member 602 can be added in order to enhance visual appeal, create a uniform top to wall 102, to add additional flexibility to the top of wall 102, or a combination thereof.

Here, although no foundation material 104 is used, it may be used in some embodiments. When using a partitioning member a foundation material 104 may or may not be used.

Further, portioning member 602 has a matching channel 404 that matches the width of wall 102. Again, partitioning member 602 does not need to include matching channel 404 and can simply rest atop of wall 102.

Here, first proximity sensor 608 and second proximity sensor 610 can be two different fiber optic sensor wires, a single fiber optic loop, an analog loop, or two analog sensor wires.

Systems described herein can further include at least one light. As illustrated in FIG. 6, at least one light 612 can be included and associated with elongated coupling member 602. Light 612 need not be associated with elongated coupling member 602. In some embodiments, a conduit can be run alongside or integral with any of the proximity sensors or wires described.

In one embodiment, at least one light 612 or lights can be illuminated white, at least from sunset to sunrise, and upon tripping of a proximity sensor can change light 612 to a red color indicating the location of an attempted penetration. In other embodiments, the lights might blink or might all turn red upon attempted penetration. The lights can be dimmable and function from dusk to dawn to save on energy costs. The lights are preferably light emitting diodes (LEDs), but can be fitted with any type of light known in the art.

Lights 612 can serve both a security function and a decorative function. As a security measure, each light 612 can illuminate to indicate where proximity sensor system had been tripped/activated. The colors of the light may vary greatly depending on the threat. For example, red might indicate danger, white might indicate intrusion in progress, and blue might indicate medical need, for example to signal paramedics to an onsite injury. In another embodiment, the lights are simply decorative. For example, lights can change colors at random or in order to direct persons to the entrance to the secured area (in case of emergency) or can simply vary colors to look like decorative holiday lights. Such lighting system can be fitted to any security system described herein.

Further, a proximity sensor system in the form of a motion detection system on the exterior portion of the wall can be activated in particular sections of the wall. Lights can be activated to warn a potential intruder that the wall is secured.

Electronics such as light controllers, proximity system controllers and batteries or power converters can be built into control box 114 or into an independent box. Solar panels that charge batteries can be used to power the lights. The lights can also be powered by a standard power grid.

In another embodiment, light band 406 in FIG. 4 can be associated with a simple point of contact motion sensor system that is embedded into elongated coupling members or as a stand alone system if elongated coupling members are not used. With such a system, light band 406 may simply be illuminated when the motion sensor system is tripped/activated. A light band can have two or more lights or a strand of lights. For example, light band 406 may include four lights.

Elongated coupling members can further include at least one internal conduit 614. Such conduits can be cut into elongated coupling members prior to installation. Conduits can also be cut after installation. Elongated coupling members can include one, two, three, four, five, six, seven, eight, nine, ten, eleven, twelve or more internal or integrated conduits. Integrated conduits can be lined with polymeric tubes, metal tubes, polymeric coatings, resin coatings, or can be unlined.

Conduits can carry wiring, liquids, or the like. Conduits can carry high voltage power, low voltage power, DC power, AC power, data lines, filer optic data lines, analog data lines, network data lines, coaxial data lines, HDMI data lines, phone lines. Data can include video, still images, voice data, computer commands, system signaling, and the like.

Wiring can be run through a conduit prior to installation of an elongated coupling member and can include snap together systems for easy installation. Wiring can also be installed in a conduit after installation of a series of elongated coupling members.

In one embodiment, different conduits can carry power, data and/or a proximity sensor systems. A control box (not illustrated) can control functions of lines running through first and second conduits.

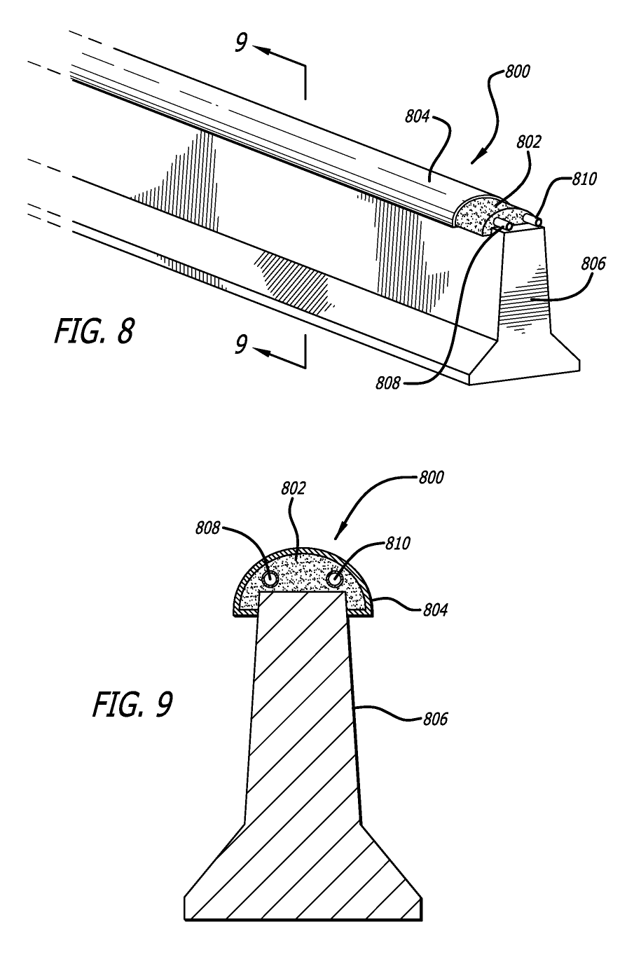

Monitoring systems are also described. Such systems can use materials, methods, and systems as described. One example monitoring system is illustrated in FIGS. 8-9. Monitoring system 800 includes at least one elongated coupling member 802 covered in coating 804. Coating can be any coating as described here. Coating 804 in one embodiment is a polyurea and/or resin coating. The coating can be formulated for application to foam materials. In one embodiment, the coating can be a resin used to coat a truck bed. The at least one elongated coupling member 802 can be attached to the top of barrier 806. Barrier 806 can be a jersey barrier commonly used on highways. Elongated coupling member 802 can be attached to barrier 806 using any methods described herein such as, but not limited to, adhesive, bolts, or friction.

Elongated coupling member 802 can further include multiple conduits running through it. In system 800, elongated coupling member 802 includes first conduit 808 and second conduit 810. First and second conduit can be lined or unlined and can carrier the same or different materials through them. In one embodiment, first conduit 808 can carry power and second conduit 810 can carry data and/or a proximity sensor system. A control box (not illustrated) can control functions of lines running through first and second conduits.

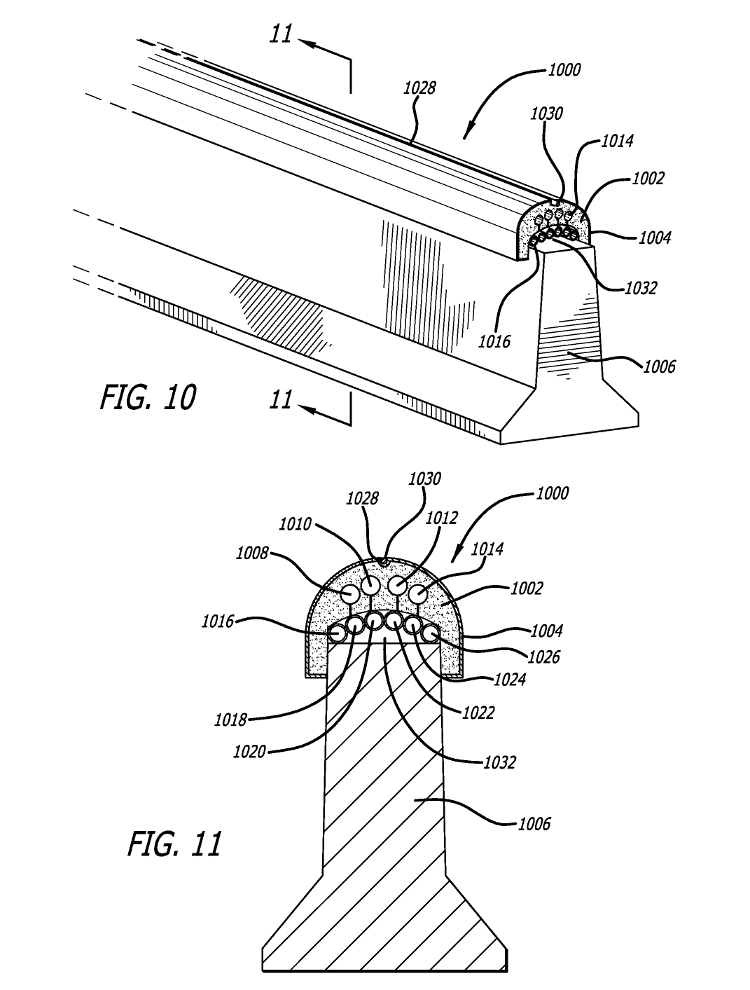

In another embodiment, a monitoring system is illustrated in FIGS. 10-11. Monitoring system 1000 includes at least one elongated coupling member 1002 covered in coating 1004. Coating can be any coating as described here. Coating 1004 in one embodiment is a polyurea and/or resin coating. The coating can be formulated for application to foam materials. In one embodiment, the coating can be a resin used to coat a truck bed. The at least one elongated coupling member 1002 can be attached to the top of barrier 1006. Barrier 1006 can be a jersey barrier commonly used on highways. Elongated coupling member 1002 can be attached to barrier 1006 using any methods described herein such as, but not limited to, adhesive, bolts, or friction.

Elongated coupling member 1002 can further include multiple conduits running through it. In system 1000, elongated coupling member 1002 can include integrated conduits such as first conduit 1008, second conduit 1010, third conduit 1012, and fourth conduit 1014. Elongated coupling member 1002 can include one, two, three, four, five, six, seven, eight, nine, ten, eleven, twelve or more internal or integrated conduits. Integrated conduits can be lined or unlined and can carrier the same or different materials through them. Integrated conduit diameter sizes are discussed above.

Elongated coupling member 1002 can further include multiple conduits running adjacent to it and optionally protected by it. In system 1000, elongated coupling member 1002 can include adjacent conduits such as first adjacent conduit 1016, second adjacent conduit 1018, third adjacent conduit 1020, fourth adjacent conduit 1022, fifth adjacent conduit 1024, and sixth adjacent conduit 1026. Adjacent conduits can be formed of any suitable material and can carrier the same or different lines through them. Suitable materials can be polymers such as plastic or metal. One, two, three, four, five, six, seven, eight, nine, ten eleven, twelve, thirteen, fourteen, or fifteen adjacent conduits can be used. Each adjacent conduit have a diameter of about 0.25 inch, about 0.5 inch, about 0.75 inch, about 1 inch, about 1.5 inches, about 2 inches or any suitable diameter.

Elongated coupling member 1002 can optionally include channel 1028. Channel 1028 can house any wire or wire system as described herein. For example, a wire can be a proximity sensor system wire 1030, which can be held in place using an adhesive.

In some embodiments, space 1032 can be created under adjacent conduits. Space 1032 can be filled with any appropriate material. In one embodiment, space 1032 can be filled with expanding foam, unexpanding foam, expanding adhesive, unexpanding adhesive, or the like. Such material can aid in attaching mentoring system 1000 to the top of barrier 1006. In other embodiments, space 1032 can remain empty.

In one embodiment, integrated conduits are not used with monitoring system 1000. In other embodiments, adjacent conduits are not used with monitoring system 1000. In some embodiments, only channel 1028 is used and no integrated conduits or adjacent conduits are used.

Conduits can carry wiring, liquids, or the like. Conduits can carry high voltage power, low voltage power, DC power, AC power, data lines, filer optic data lines, analog data lines, network data lines, coaxial data lines, HDMI data lines, phone lines. Data can include video, still images, voice data, computer commands, system signaling, and the like. Data can be used or acquired by and/or power can be used by cameras, camera systems, lights, signs, signals, radar detectors, transponder interfaces, speed sensors, traffic sensors, and the like.

In another embodiment, monitoring and security systems described herein can include a cap. A cap can be a protective covering that may not physically touch a proximity sensor associated with a wall, barrier, or structure. However, the cap can come into contact with the sensor upon a particular pressure applied to the cap.

An exposed or semi-exposed proximity sensor can in some cases detect even a slight vibration on the wire, especially when associated with exposed flexible foam. Even a touch such as a bird landing on the foam or sensor itself can trigger the systems described. If sensitivity is an issue, a cap as described can be added to any system described herein.

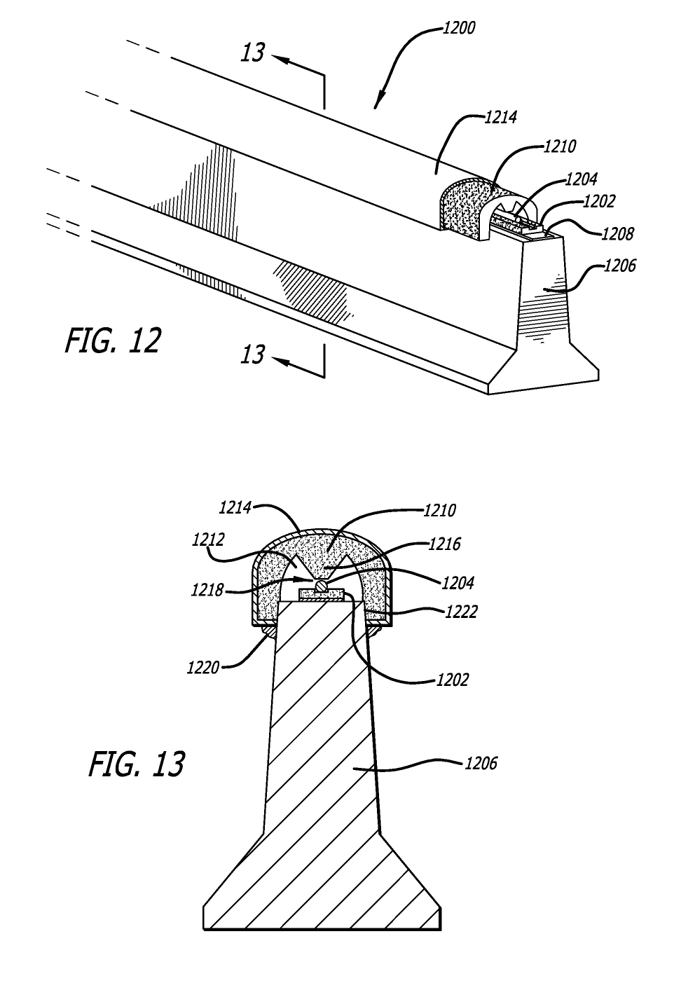

A monitoring system including an exemplary cap is illustrated in FIGS. 12-13. Monitoring system 1200 includes an elongated coupling member 1202 having an associated proximity sensor 1204 or proximinity sensor system as described herein, or a material system such as system 100. Proximity sensor 1204 can be encased in a conduit or can be simply attached to elongated coupling member 1202. Elongated coupling member 1202 can be attached to barrier 1206 or a wall or structure using any method described herein such as adhesive or bolts. Also, elongated coupling member can be formed in any configuration or shape as described herein can be formed of any appropriate material described herein. In one embodiment, elongated coupling member 1202 can be formed of foam and have a shape of a channel. In other aspects, elongated coupling member can be attached to barrier 1206 using an adhesive 1208 such as a mastic.

Elongated coupling member 1202 can have any width that allows it to sit atop of barrier 1206 without interacting with a cap. Widths can be about ½ in, about 1 in, about 2 in, about 3 in or about 4 in.

Also as described herein, elongated coupling member 1202 can include one or more conduits for carrying power, data and/or the like. Conduits can be integrated into elongated coupling member 1202 or can be associated with the outside thereof. One, two, three, four, five, six, seven, eight, nine, ten, eleven, twelve or conduits can be associated with elongated coupling member 1202. Each conduit can have a diameter of about ¼ inch, about ½ inch, about ¾ inch, about 1 inch, about 1.5 inches, about 2 inches or any suitable diameter.

Protective cap 1210 can be added to aid in preventing false alarms. Cap 1210 can be formed in a shape that can completely encase proximity sensor 1202 while creating space 1212 around proximity sensor 1204. In other embodiments, a cap need to completely encase a proximity sensor; rather, cap can have open sections but still prevent certain types of impacts. Protective cap 1210 can be formed of any material described herein. In some embodiments, protective cap 1210 is formed of high density foam. Protective cap 1210 can further be covered in coating 1214. Coating can be any material described. In one embodiment, coating 1214 can be a resin such as a tuck bed liner material. Protective cap 1210 can be coated in the inside, on the outside, or both. In one embodiment, protective cap 1210 is only coated on the outside.

As illustrated in FIGS. 12-13, protective cap 1210 can include protrusion 1216 on its inside surface and over proximity sensor 1204. Protrusion 1216 can provide gap 1218 over proximity sensor. Gap 1218 can be about 1/256 in, about 1/128 in, about 1/64 in, about 1/32 in, about 1/16 in, about ⅛ in, about ¼ in, about ½ in, about ¾ in, about 1 in, about 2 in, about 3 in, about 4 in, about 5 in, about 6 in, at least about 1/256 in, at least about 1/128 in, at least about 1/64 in, less than about 2 in, less than about 1 in, less than about ½ in, less than about ¼ in, less than about 1/16 in, between about 1/256 in and about 1 in, between about 1/256 in and about ½ in, between about 1/64 in and about 1 in, or between about 1/16 in and about 1 in.

Protrusion 1216 can be configured to touch proximity sensor 1204, based on gap 1218, when a given amount of force is applied to protective cap 1210. Pressures that can be applied to protective cap 1210 which cause protrusion 1216 to touch proximity sensor 1204 can be about 2 N, about 3N, about 4 N, about 5 N, about 6 N, about 7 N, about 8 N, about 9 N, about 10 N, about 15 N, about 20 N, about 25 N, about 30 N, about 35 N, about 40 N, about 45 N, about 50 N, about 75 N, about 100 N, about 200 N, about 300 N, about 400 N, about 500 N, at least about 2 N, at least about 3N, at least about 4 N, at least about 5 N, at least about 6 N, at least about 7 N, at least about 8 N, at least about 9 N, at least about 10 N, at least about 15 N, at least about 20 N, at least about 25 N, at least about 30 N, at least about 35 N, at least about 40 N, at least about 45 N, at least about 50 N, between about 2 N and about 500 N, between about 2 N and about 100 N, between about 5 N and about 100 N, or between about 4 N and about 20 N.

Different gaps and foam densities of protective cap 1210 can be combined by a skilled artisan to achieve a particular force requirement to trip proximity sensor 1204. In some embodiments, protrusion 1216 can be shaped and gap 1218 measured to signal a particular event based on pressure applied to protective cap 1210. Also, protrusion 1216 can be shaped to allow contact with proximity sensor 1204 when cap 1210 is contacted at particular areas or at particular angles. For example, as illustrated in FIG. 13, protrusion 1216 may be suited to detect a pressure applied to the top of protective cap 1210. In another embodiment, protrusions may be added to the underside of protective cap 1210 along the sides thereby allowing detection of pressures applied to the sides of protective cap 1210.

In some embodiments, protective cap 1210 may not need a protrusion at all. Protective cap 1210 can merely add protection from minor impacts with proximity sensor and allow only major impacts with protective cap 1210 or barrier 1206 to be detected. For example, if only major impacts such as a car colliding with barrier 1206 are required to be reported, a protrusion may not be needed on protective cap 1210 as such an impact alone with barrier 1206 can trip the proximity sensor.

Protective cap 1210 can be connected to barrier 1206 using any method or material described herein. In one embodiment, protective cap 1210 is snapped onto barrier 1206 using friction. In another embodiment, after snapping protective cap 1210 onto battier 1206, adhesive 1220 can be used to seal cap onto barrier 1206. Cap can further include channels shaped like the top of the wall, barrier or structure it is to be applied to in order to provide a better seal. However, these channels may not be needed.

Protective cap 1210 can include one or more conduits for carrying power, data and/or the like. Conduits can be integrated into protective cap 1210 or can be associated with the outside thereof. One, two, three, four, five, six, seven, eight, nine, ten, eleven, twelve or conduits can be associated with protective cap 1210. Each conduit can have a diameter of about ¼ inch, about ½ inch, about ¾ inch, about 1 inch, about 1.5 inches, about 2 inches or any suitable diameter.

Protective cap 1210 installed over a proximity sensor system as described can create a space 1212 over the proximity system. In some embodiments, space 1212 can be filled with any appropriate material that can absorb shock to a desired degree. In one embodiment, space 1212 can be filled with expanding foam, unexpanding foam, expanding adhesive, unexpanding adhesive, or the like. Such material can aid in attaching protective cap 1210 to barrier 1206, but at the same time absorb forces applied to protective cap 1210 without transferring undesired detection forces to proximity sensor 1204. In other embodiments, space 1212 can remain empty.

Monitoring systems described herein can be used to detect movement or impact with the wall, barrier, or structure the system is mounted on. Through a control box or other computing device, a signal can be directed to an off-site or remote system that an event has occurred. Proper authorities can be contacted upon detection of the signal. In one embodiment, the monitoring systems can be installed on highway medians and can detect collisions with the median. Upon detection of a collision, police, fire, paramedic or other authority can be contacted and dispatched.

Generally, to install a system as described herein not including a partitioning member, steps such as, but not limited to, the following are utilized. First an existing wall can be chosen for security system installation or a new wall can be constructed for the purpose of installing a security system. Then, the wall's surface can be cleaned. Cleaning can be with a machine such as a pressure washer. Water can be used with the pressure washer or water including a cleaner such as a 5% chlorine solution. The wall can then be allowed to dry.

After the wall is dry, a foundation material can be applied to the top of the wall. In some embodiments, the foundation material can be brushed, rolled or sprayed on the top of the wall. Preferably, while foundation material is still tacky, a first encasing layer can be placed in the middle of the top of the wall along its entire length. The foundation material may be allowed to soak into a porous or absorbent encasing layer.

A fiber optic wire or other electronic sensor can then be positioned in the center of the first encasing layer. At this point, a second encasing layer can be placed on top of the fiber optic wire thereby encasing the fiber optic wire. A top material such as the same material used as the foundation material can be coated on top of the encased fiber optic wire. Multiple coats may be applied on top of the first layer of top material.

After the one or more layers of top material have dried, the entire system just installed can be painted to match the color of the existing wall or even another decorative color. In one embodiment, the system can be painted the color of the existing wall to prevent detection of the system's presence. In some embodiments, the system need not be painted. In other embodiments, the foundation material and top material can be pre-dyed to color match the existing wall thereby eliminating the painting step.

The fiber optic wire can be operatively connected to one or more controllers, CPUs, processors, computer systems and/or alarm systems and activated thereby securing the area inside the wall.

In another embodiment, a system can include an elongated coupling member. After the wall has been cleaned as dried as described, an elongated coupling member(s) can be attached to the top of the wall using an adhesive, bolts or both. Then, a foundation material can be applied to the top of the elongated coupling member(s). In some embodiments, the foundation material can be brushed, rolled or sprayed on the elongated coupling member(s). Preferably, while foundation material is still tacky, a first encasing layer can be placed in the middle of the top of the elongated coupling member(s) along its entire length. The foundation material may be allowed to soak into a porous or absorbent encasing layer.

A fiber optic wire or other electronic sensor can then be positioned in the center of the first encasing layer. At this point, a second encasing layer can be placed on top of the fiber optic wire thereby encasing it. A top material such as the same material used as the foundation material can be coated on top of the encased fiber optic wire. Multiple coats may be applied on top of the first layer of top material.

After the one or more layers of top material have dried, the entire system just installed can be painted to match the color of the existing wall or even another decorative color. However, in one embodiment, the system can be painted the color of the existing wall to prevent detection of the system's presence. In some embodiments, the system need not be painted. In other embodiments, the foundation material and top material can be pre-dyed to color match the existing wall thereby eliminating the painting step.

The fiber optic wire can be operatively connected to one or more controllers, CPUs, processors, computer systems and/or alarm systems and activated thereby securing the area inside the wall or monitoring the wall, barrier, or structure itself.

A security system can be installed that may or may not require an elongated coupling member. In one embodiment, another security system can be constructed with an elongated coupling member.

In another embodiment, a monitoring system can include an elongated coupling member with one or more integrated conduit and/or one or more adjacent conduit. After the wall has been cleaned as dried as described, an elongated coupling member(s) can be attached to the top of the wall using an adhesive, bolts or both. Then, a coating can be applied to the top of the elongated coupling member(s). In one embodiment, the coating is with resin similar to truck bed-liner material. In some embodiments, the coating material can be brushed, rolled or sprayed on the elongated coupling member(s). In another embodiment, elongated coupling members can be coated prior to installation.

The systems described herein when used for security can further include an audible alarm. Speakers can be built into the stakes or horns, or other announcing devices can be associated with the wall. Audible alarms sounds can be emitted from the system or verbal warning can be echoed through the system.

The security systems described herein once installed and calibrated generally activate before an intrusion takes place, for example, when motion is detected, when something is propped up against a sensor, or a sensor is touched.

The system alone, without being activated, provides several deterrents to prevent an intruder from even attempting to overcome the security systems. If warning signs or indications in or on the wall itself translate to a potential intruder, general fears of audible alarms or bright lights activated by the system can prevent a potential intrusion.

The systems and methods described herein can eliminate cost when compared to conventional systems. For example, if no elongated coupling member is used the cost can be reduced at least for the cost of the material itself. Further, if foam is used, mastic may be required as well as caulking as a base product tool to hold it to the walls. For example, the present systems can reduce costs by about 10 times, about 20 times, or about 30 times when compared to a traditional wall security system. Further, the systems described herein can be installed on top of an existing wall, barrier, or structure without the need to acquire a building or planning department permit. This can reduce costs even further.

The systems described can be pliable enough to conduct vibrations calibrated to more than about 10#, 15#, 20#, 30#, 40# or 50# weight through a fiber optic wire or analogue wire.

The systems described herein can add less than about 8 inches, 7 inches, 6 inches, about 5 inches, about 4 inches, about 3 inches, about 2 inches, about 1 inch, about 0.5 inches, about 0.25 inches, about 0.1 inch or about 0.01 inch to the top of a wall.

The systems described can further stand up to environmental elements. The systems either painted or unpainted can sustain UV protection for at least 3 years, at least 5 years, at least 7 years, at least 10 years, at least 15 years, at least 20 years, at least 30 years, at least 40 years, or more. The systems can further withstand temperature fluctuations from about −50 F to about 200 F, about −30 F to about 150 F, about −20 F to about 120 F, or and range created by the values listed.

The materials used for the foundation material and the top material can be flexible to withstand both hot and cold climates. For example, the materials can expand about 105%, about 110%, about 115%, about 120%, about 125%, about 130%, about 135%, about 140%, about 145%, about 150%, about 160%, about 170%, about 180%, about 190%, or about 200% of their original length.

### Example 1

### Installing a Security System on an Existing Cinder Block Wall

A six foot tall cinder block wall is selected to be secured. The wall is pressure washed with 5% chloride solution at a pressure of about 1,300 psi. After washing, the wall is allowed to dry.

Then a vulcanized liquid rubber is rolled four inches wide along the top of the wall using a 4″ roller. Two or three coats can be applied. While still tacky, a two inch cloth strip is laid along the top center of the vulcanized rubber layer. The vulcanized rubber layer can absorb into the fabric. Then, the fiber wire is centered on the fabric cloth strip. A second two inch cloth strip is placed on top of the fiber wire and centered over the first cloth strip. Another layer of vulcanized rubber is rolled on top of the entire original rubber layer(s) and fabric layer-fiber wire-fabric layer sandwich. This application of rubber can be repeated as necessary to achieve a desired thickness. After application of an appropriate number of rubber layers, the entire system is allowed to dry overnight.

When dry, the system can be painted a desired color. A fiber controller is attached at one or both ends of the fiber optic wire and the fiber controller can be hooked to a central controller. The system can then be armed.

### Example 2

### Installing a Security System Including an Elongated Coupling Member on an Existing Cinder Block Wall

A six foot tall cinder block wall is selected to be secured. The wall is pressure washed with 5% chloride solution at a pressure of about 1,300 psi. After washing, the wall is allowed to dry.

Then, elongated coupling members are attached to the top of the wall using an appropriate adhesive. The adhesive is allowed to dry. Then, vulcanized liquid rubber is rolled along the top of the elongated coupling members using a roller. Two or three coats can be applied. While still tacky, a two inch cloth strip is laid along the top center of the vulcanized rubber layer. The vulcanized rubber layer can absorb into the fabric. Then, the fiber wire is centered on the fabric cloth strip. A second two inch cloth strip is placed on top of the fiber wire and centered over the first cloth strip. Another layer of vulcanized rubber is rolled on top of the entire original rubber layer(s) and fabric layer-fiber wire-fabric layer sandwich. This application of rubber can be repeated as necessary to achieve a desired thickness. After application of an appropriate number of rubber layers, the entire system is allowed to dry overnight.

When dry, the system can be painted a desired color. A fiber controller is attached at one or both ends of the fiber optic wire and the fiber controller can be hooked to a central controller. The system can then be armed.

### Example 3

### Installing a Conduit System on a Jersey Barrier

A preexisting jersey barrier is located in the center of a freeway or expressway. A six inch tall elongated coupling member coated in a bed-liner material including two internal conduits is glued to the top of the jersey barrier. Subsequent elongated coupling members are attached to the jersey barrier as necessary to complete the length of the jersey barrier.

After installation, a communication line is run through one conduit to allow remote accessibility of a control box. A proximity sensor is installed in the same conduit to detect impacts with the jersey barrier. High and low voltage power are run though the other conduit to power lights, signs, and the controller box.

### Example 4

### Installing a Conduit System on a Jersey Barrier

A preexisting jersey barrier is located in the center of a freeway or expressway. A six inch tall elongated coupling member coated in a bed-liner material including four internal conduits chosen for the system. Six adjacent conduit pipes are glued to the top of the jersey barrier. Then, elongated coupling members including four integrated conduits are attached to the jersey barrier on top of the adjacent conduits. Subsequent conduits and elongated coupling members are added as needed to complete a length of jersey barrier.

After installation, a communication line is run through one adjacent conduit to allow remote accessibility of a control box. A proximity sensor is installed in an integrated conduit to detect impacts with the jersey barrier. High and low voltage power are run though the adjacent conduit to power lights, cameras, signs, and the controller box.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

I claim:

1. A security system comprising:
a structure topped with at least two layers of a binding agent, and at least one proximity sensor encased within the at least two layers of the binding agent.

2. The security system of claim 1, further including at least one elongated coupling member between the structure and the at least two layers of the binding agent.

3. The security system of claim 2, wherein the elongated coupling member is formed of foam.

4. The security system of claim 1, further including a first encapsulating layer and a second encapsulating layer surrounding the at least one proximity sensor.

5. The security system of claim 2, wherein said at least one elongated coupling member is attached to the structure using an adhesive.

6. The security system of claim 1, wherein the at least one proximity sensor system includes at least one of a motion detection system, a pressure detection system, a shock detection system, and an infrared detection system.

7. The security system of claim 1, wherein said at least one proximity sensor system is housed within said at least one conduit channel.

8. The security system of claim 1, wherein said security system adds less than about 1 inch of height to the structure.

9. A security system comprising: a proximity sensor encased in a fabric layer, wherein the fabric layer encased within a vulcanized rubber material, and wherein the vulcanized rubber material applied to the top of a wall.

10. A monitoring system comprising:
at least one elongated coupling member including at least one conduit coupled to a structure; and
at least one line proximity sensor running through the at least one conduit.

11. The monitoring system according to claim 10, wherein the structure is a jersey barrier.

12. The monitoring system according to claim 10, wherein the elongated coupling member includes at least two conduits.

13. The monitoring system according to claim 10, wherein the conduits are integrated conduits.

14. The monitoring system according to claim 10, wherein the conduits are adjacent conduits.

15. The monitoring system according to claim 10, wherein the elongated coupling member is between about 2 inches and about 8 inches tall.

16. The monitoring system according to claim 10, further comprising a data line, a power line, or both.

17. The monitoring system according to claim 10, wherein the system is configured to detect an impact and log that impact on a remote computer.

18. The monitoring system according to claim 10, wherein the elongated coupling member includes a foam.

19. The monitoring system according to claim 10, further comprising a protective cap over the elongated coupling member.

20. The monitoring system according to claim 10, wherein the structure is a walkway, wall, fence, roof line, parapet, window, platform, platform edge, door threshold, barrier, or combination thereof.
